(19) United States
(12) Patent Application Publication
(10) Pub. No.: US 2010/0231865 A1
(43) Pub. Date: Sep. 16, 2010

(54) PICTURE DISPLAY APPARATUS

(76) Inventor: Kazushi Yoshida, Shizuoka (JP)

Correspondence Address: MCCORMICK, PAULDING & HUBER LLP, CITY PLACE II, 185 ASYLUM STREET, HARTFORD, CT, 06103, US

(21) Appl. No.: 12/298,805

(22) PCT Filed: Apr. 26, 2007
(86) PCT No.: PCT/JP2007/059076

§ 371 Date: Oct. 28, 2008

(30) Foreign Application Priority Data
Apr. 28, 2006 (JP) 2006-126332

(51) Int. Cl. G03B 21/28; G03B 21/14

(52) U.S. Cl. 353/33

(57) ABSTRACT

[Subject] A picture display apparatus is provided which can be miniaturized and has high illumination efficiency.

[Means for Solving the Problems] A picture display apparatus includes a light source; a light-condensing optical system which condenses rays of light from the light source to form an imaginary secondary light source; an optical member on which the rays of light that are condensed by the light-condensing optical system are incident; a right-angle prism through which the rays of light that exit from the optical member pass; a relay lens through which the rays of light that exit from the right-angle prism pass; an image forming element on which the rays of light that exit from the relay lens are incident; and a projector lens on which the rays of light that pass through the image forming element are incident, and which magnifies and projects the rays of light incident on the projector lens. Five surfaces which constitute the right-angle prism are all formed as polished surfaces and disposed in a close vicinity of an exit surface of the optical member.

### FIELD OF THE INVENTION

The present invention relates to a picture display apparatus using pixels arranged in the form of a matrix, wherein each pixel is turned ON or OFF to form a picture image.

### BACKGROUND OF THE INVENTION

As conventional picture image apparatuses, for instance, image apparatuses shown in FIGS. 12 through 14 are known in the art.

In the picture image apparatus 100 shown in FIG. 12, RGB rays of light from three LED light sources 101, 102 and 103 are incident on a first reflecting mirror 110 via condenser lenses 104, 105 and 106, two dichroic filters 107 and 108 and a condenser lens 109, and the light reflected by the first reflecting mirror 110 is incident on a second reflecting mirror 120 via a light tunnel (or rod lens) 111 and a relay lens 112. The light reflected by the second reflecting mirror 120 travels in a direction parallel to the incident light on the first reflecting mirror 110 and opposite to the traveling direction thereof, and is incident on an image forming element 130 via the relay lens 121. The incident light on the image forming element 130 is projected therefrom as a desired image by switching ON and OFF pixel portions arranged in a matrix form onto a screen (not shown) via a projector lens 140. In the picture display apparatus 100, by making the traveling direction of the incident light on the first reflecting mirror 110 and the traveling direction of the reflected light from the second reflecting mirror 120 parallel to each other and arranging many of the components of the picture display apparatus 100 on these traveling direction, the picture display apparatus 100 is miniaturized in a direction orthogonal to the traveling directions.

In the picture display apparatus 200 shown in FIG. 13, RGB rays of light from three LED light sources 201, 202 and 203 enter into a dichroic prism 210 from three surfaces thereof, via light tunnels (or rod lenses) 204, 205, 206, and emerge from a different surface of the dichroic prism 210 toward an image forming element 220. The incident light on the image forming element 220 is projected therefrom as a desired image by switching ON and OFF pixel portions arranged in a matrix form onto a screen (not shown) via a projector lens 230. In the picture display apparatus 200, a reduction in number of the optical elements thereof can be achieved because the apparatus is configured so that RGB rays of light are incident on the dichroic prism 210 from three directions.

In the picture display apparatus 300 shown in FIG. 14, light from a light source 301 is condensed by a condenser mirror 302 to be incident on a light tunnel 303. The outgoing light from the light tunnel 303 is reflected by a first reflecting mirror 310 to be incident on a second reflecting mirror 320 via a relay lens 311. The reflected light from the second reflecting mirror 320 is incident on an image forming element 330 via a relay lens 321. This incident light is exited toward a projector lens 340 as a desired image by switching ON and OFF pixel portions arranged in a matrix form to be projected onto a screen (not shown). In the picture display apparatus 300, by making the traveling direction of the incident light on the first reflecting mirror 310 and the traveling direction of the reflected light from the second reflecting mirror 320 parallel to each other and arranging many of the components of the picture display apparatus 300 on these traveling directions, the picture display apparatus 300 is miniaturized in a direction orthogonal to the traveling directions.

### DISCLOSURE OF THE INVENTION

### Problem to be Solved by the Invention

However, in the picture display apparatus 100 shown in FIG. 12, a great number of optical elements such as the condenser lenses 104, 105 and 106, which correspond to the three LED light sources, respectively, the dichroic filters 105 and 106, the condenser lens 107 and others, and the apparatus cannot avoid increasing in size because of the installation of such a large number of optical elements.

On the other hand, in the picture display apparatus 200 shown in FIG. 13, there is a problem of having difficulty in miniaturizing the apparatus because the three LED light sources 201, 202 and 203 are arranged on three sides of the dichroic prism 210, respectively.

In addition, in the picture display apparatus 300 shown in FIG. 14, since the apparatus is structured so that the outgoing light from the light tunnel 303 is reflected by the first reflecting mirror 310 to be incident on the relay lens 311, the relay lens 311 must be increased in diameter so as to make the reflected light from the first reflecting mirror 310 entirely incident on the relay lens 311. Additionally, to make the outgoing light from the light tunnel 303 totally reflected in a desired direction, it is necessary to position the first reflecting mirror 310 sufficiently apart from the light tunnel 303. However, in this case, the distance between the second reflecting mirror and the image forming element 330 increases due to optical design.

### Means for Solving the Problem

To solve the above described problems, a picture display apparatus of the present invention is characterized by alight source; a light-condensing optical system which condenses rays of light from the light source to form an imaginary secondary light source; an optical member on which the rays of light that are condensed by the light-condensing optical system are incident; a right-angle prism through which the rays of light that exit from the optical member pass; a relay lens through which the rays of light that exit from the right-angle prism pass; an image forming element on which the rays of light that exit from the relay lens are incident; and a projector lens on which the rays of light that pass through the image forming element are incident, and which magnifies and projects the rays of light incident on the projector lens. Five surfaces which constitute the right-angle prism are all formed as polished surfaces and disposed in a close vicinity of an exit surface of the optical member.

In addition, a picture display apparatus of the present invention is characterized by a light source; a light-condensing optical system which condenses rays of light from the light source to form an imaginary secondary light source; a right-angle prism on which the rays of light that are condensed by the light-condensing optical system are incident; an optical member through which the rays of light that exit from the right-angle prism pass; a relay lens through which the rays of light that exit from the optical element pass; an image forming element on which the rays of light that exit from the relay lens are incident; and a projector lens on which the rays of light that pass through the image forming element are incident, and which magnifies and projects the rays of light incident on the projector lens. Five surfaces which constitute the right-angle prism are all formed as polished surfaces and positioned in a close vicinity of an incident surface of the optical member.

Additionally, a picture display apparatus of the present invention according to another aspect is characterized by three LED light sources which emit red light, green light and blue light, respectively; three optical members which are arranged parallel to one another and on which rays of the red light, rays of the green light and rays of the blue light from the three LED light sources are incident, respectively; two right-angle prisms corresponding to two of the three optical members except for a central optical member thereof, light rays which exit from the two of the three optical members passing through the two right-angle prisms, respectively; a dichroic prism on which the light rays that exit from the central optical member and the light rays that exit from the two of the three optical members are incident, and which combines the red, green and blue light rays together and allows the combined light rays pass therethrough; an image forming element on which the light rays that exit from the dichroic prism are incident; and a projector lens on which the light rays that pass through the image forming element are incident, and which magnifies and projects the light rays incident on the projector lens. Six outer surfaces which constitute the dichroic prism are all formed as polished surfaces, and five surfaces which constitute each of the right-angle prisms are all formed as polished surfaces. The right-angle prisms are disposed in a close vicinity of exit surfaces of the two of the three optical members except for the central optical member, respectively. An air distance exists between each the right-angle prism and the dichroic prism.

According to a further aspect, a picture display apparatus of the present invention is characterized by three LED light sources which emit red light, green light, and blue light, respectively; three optical members which are arranged parallel to one another and on which rays of the red light, rays of the green light and rays of the blue light from the three LED light sources are incident, respectively; right-angle prisms corresponding to two of the three optical members except for a central optical member thereof, light rays which exit from the two of the three optical members passing through the two right-angle prisms, respectively; three image forming elements on which the light rays that exit from the central optical member and the light rays that exit from the two of the three optical members are incident; a dichroic prism on which the light rays that exit from the three image forming elements are incident, and which combines the light rays incident on the dichroic prism together and allows the combined light rays to pass therethrough; a projector lens on which the light rays that pass through the dichroic prism are incident, and which magnifies and projects the light rays incident on the projector lens. Six outer surfaces which constitute the dichroic prism are all formed as polished surfaces, and five surfaces which constitute each of the right-angle prisms are all formed as polished surfaces. The right-angle prisms are disposed in a close vicinity of exit surfaces of the two of the three optical members except for the central optical member, respectively. An air distance exists between each of the right-angle prisms and the dichroic prism.

The oblique surface of the right-angle prism can be subjected to a reflection treatment.

The optical member can be composed of a light tunnel.

The optical member can be composed of a rod lens. In this case, it is desirable that an air distance exists between each rod lens and the associated right-angle prism.

It is desirable that the light-condensing optical system be a condenser mirror.

It is desirable that the light source be an LED and that the light-condensing optical system be a condenser lens system.

According to a further aspect, a picture display apparatus, of the present invention, equipped with a projector lens which magnifies and projects incident light is characterized by three LED light sources which emit red light, green light, and blue light, respectively; three optical members which are arranged parallel to one another and on which rays of the red light, rays of the green light and rays of the blue light from the three LED light sources are incident, respectively; a right-angle prism through which light rays, which exit from an optical member among the three optical members positioned on a far side from the projector lens, pass; a first dichroic prism on which the light rays that exit from a central optical member among the three optical members and the light rays that exit from the right-angle prism are incident, and which combines two of the red, green and blue light rays together and allows the combined light rays pass therethrough; a second dichroic prism on which the light rays that exit from an optical member among the three optical members which is positioned on the projector lens side and the light rays that exit from the first dichroic prism are incident, and which combines the red, green and blue light rays together and allows the combined light rays pass therethrough; and an image forming element on which the light rays that exit from the second dichroic prism are incident and pass through the image forming element toward the projector lens. Six outer surfaces which constitute the first dichroic prism and six outer surfaces which constitute the second dichroic prism are all formed as polished surfaces, and five surfaces which constitute the right-angle prism are all formed as polished surfaces. The right-angle prism is disposed in a close vicinity of an exit surface of an optical member among the three optical members which is positioned on a far side from the projector lens. The first dichroic prism is disposed in a vicinity of an exit surface of the right-angle prism and an exit surface of the central optical member. The second dichroic prism is disposed in a close vicinity of an exit surface of the first dichroic prism and an exit surface of an optical member among the three optical members which is positioned on the projector lens side. An air distance exists between the right-angle prism and the first dichroic prism and an air distance exists between first dichroic prism and the second dichroic prism.

### BRIEF DESCRIPTION OF THE DRAWINGS

FIG. 1 is a plan view of a first embodiment of a picture display apparatus of the present invention, showing the overall structure thereof;

FIG. 2 show diagrams showing the structure of a right-angle prism, wherein (a) is a perspective view viewed from an oblique surface and upper surface side and (b) is a side view viewed from the oblique surface side;

FIG. 3 is an enlarged view of a portion of the picture display apparatus shown in FIG. 1 in the vicinity of the right-angle prism;

FIG. 4 is a diagram showing a state of travel of a ray of light in the case where the rod lens and the right-angle prism shown in FIG. 3 are brought into intimate contact with each other;

FIG. 5 is a diagram showing a state of total reflection at the oblique surface of the right-angle prism of the embodiment of the present invention;

FIG. 6 is a plan view showing the overall structure of a second embodiment of the picture display apparatus of the present invention;

FIG. 7 is a diagram showing a state where rays of light emitted from a light source shown in FIG. 6 are totally reflected at a surface of the right-angle prism;

FIG. 8 is a diagram showing a state where rays of light emitted from a light source shown in FIG. 6 are totally reflected at a surface of the dichroic prism;

FIG. 9 is an overview of a comparative example to be compared with the second embodiment of the present invention, showing a structure using a mirror instead of the right-angle prism;

FIG. 10 is a state of travel of rays of light in the comparative example to be compared with the second embodiment of the present invention;

FIG. 11 is a plan view showing the overall structure of a third embodiment of the picture display apparatus of the present invention;

FIG. 12 is an overview of a conventional picture display apparatus using LED light sources of three colors;

FIG. 13 is an overview showing a conventional picture display apparatus using LED light sources of three colors and a dichroic prism; and

FIG. 14 is an overview showing a conventional picture display apparatus.

### PREFERRED EMBODIMENTS OF THE INVENTION

### First Embodiment

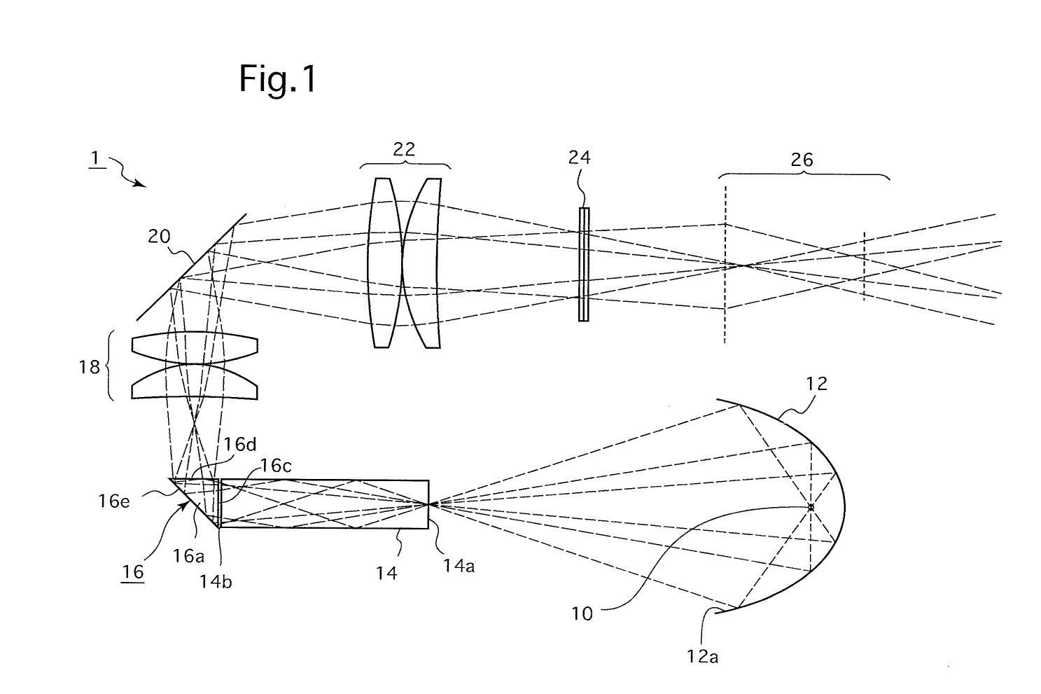

A first embodiment of a picture display apparatus according to the present invention will be hereinafter discussed in detail with reference to drawings. As shown in FIG. 1, the first embodiment of the picture display apparatus 1 is provided with a light source 10, a condenser mirror 12, a light tunnel 14, a right-angle prism 16, a first relay lens system 18, a reflecting mirror 20, a second relay lens system 22, an image forming element 24 and a projector lens system (projector lens) 26.

The light source 10 is a white light source; and for instance, a halogen lamp, a xenon lamp, a metal halide lamp or a super-high pressure mercury lamp can be used.

The condenser mirror (light-condensing optical system) 12 is arranged so as to surround the light source 10 and shaped so that a portion of the condenser mirror 12 on the light tunnel 14 side is open as a light exit opening. The condenser mirror 12 reflects and condenses light which radiates out from the light source 10, and makes this light exit toward the light tunnel 14 from the light exit opening 12a to form an imaginary secondary light source on the incident surface of the light tunnel 14.

The light tunnel (optical member) 14 is capable of making the incident light, which enters into the light tunnel 14 from one end surface (incident surface) 14a of the rectangular body of the light tunnel 14, exit from the other end surface (exit surface) 14b as light having a uniformed light quantity, uniformed by reflecting the incident light by the inner surfaces of the light tunnel 14.

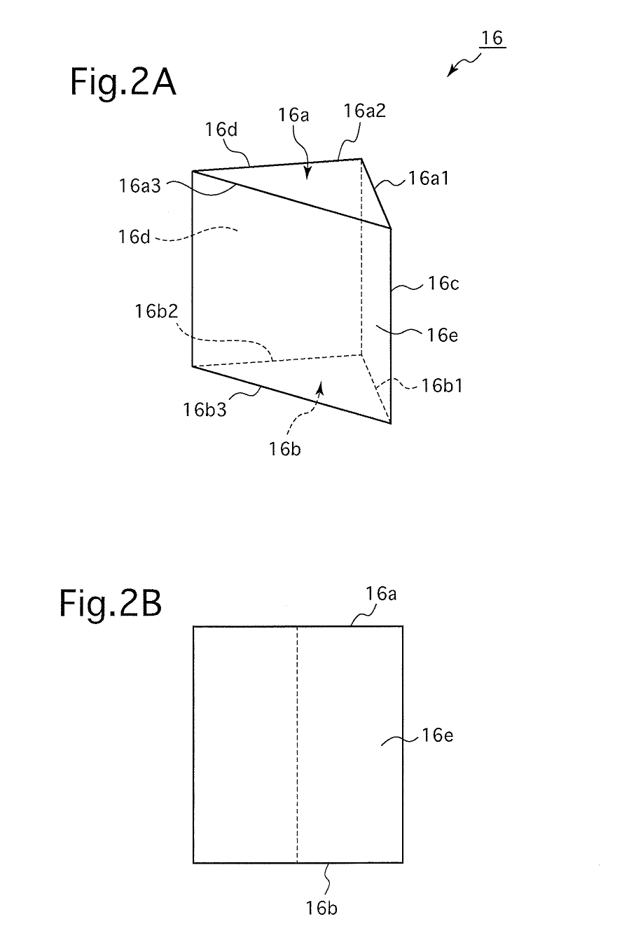

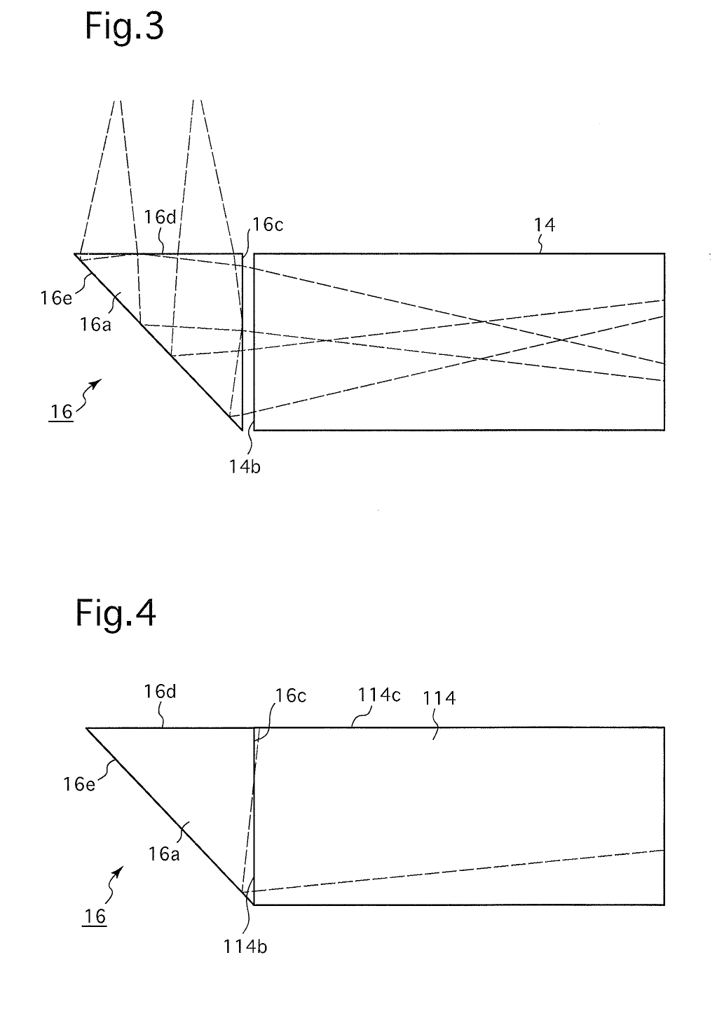

The outgoing light from the exit surface 14b of the light tunnel 14 is incident on the right-angle prism 16 that is positioned with a side surface 16c thereof being positioned in the close vicinity of the exit surface 14b of the light tunnel 14 (for instance, in the range from 0 mm to smaller than 10 mm in the case where the exit surface 14b is in the shape of a rectangle of 10 mm×8 mm). The outgoing light from the exit surface 14b can be made to efficiently enter into the right-angle prism 16 by positioning the side surface 16c in the vicinity of the exit surface 14b. As shown in FIG. 2, the right-angle prism 16 is shaped into a triangle prism having an upper surface 16a and a bottom surface 16b, each of which is shaped as an isosceles triangle. The right-angle prism 16 is composed of the upper surface 16a and the bottom surface 16b, two side surfaces 16c and 16d, and an oblique surface 16e, which constitute a triangular prism shape, wherein the two surface 16c and 16d extend from two sides 16a1 and 16a2 of the upper surface 16a, which are orthogonal to each other, to corresponding two sides 16b1 and 16b2 of the bottom surface 16b, respectively, and the oblique surface 16e extends from an oblique side 16a3 of the upper surface 16a to an oblique side surface 16b3 of the bottom surface 16b. All the five surfaces 16a, 16b, 16c, 16d and 16e are polished surfaces. As shown in FIGS. 1 and 3, the outgoing light from the light tunnel 14 enters from the side surface 16c, and is incident on the oblique surface 16e directly or after being totally reflected by the upper surface 16a, the bottom surface 16b or the side surface 16d. The incident light on the oblique surface 16e is reflected by the oblique surface 16e, and exits from the side surface 16d directly or after being totally reflected by the upper surface 16a, the bottom surface 16b or the side surface 16c.

A rod lens (rod-shaped glass lens) 114 can be used instead of the light tunnel 14. In this case, it is desirable to provide an air distance (e.g., more than 0 and less than 10 mm) between the exit surface of the rod lens and the right-angle prism 16. In contrast, if the rod lens 114 and the right-angle prism 16 are made intimate contact with each other with the distance between the exit surface 114b of the rod lens 114 and the side surface (incident surface) 16c of the right-angle prism 16 being set to zero as shown in FIG. 4, some of the outgoing light from the rod lens 114 is totally reflected by each surface of the right-angle prism 16 according to the conditions which will be discussed later after being incident on the right-angle prism 16, thereafter again passes through the incident surface 16c of the right-angle prism 16 and reaches the side surface 114c of the rod lens 114. The existence of this sort of light reduces the uniformity of the outgoing light at the exit surface (side surface) 16d of the right-angle prism 16 in the vicinity of the rod lens 114, and further reduces illumination efficiency. Therefore, to prevent this sort of problem from occurring, it is desirable that the distance between the exit surface 114b of the rod lens 114 and the incident surface 16c of the right-angle prism 16 be greater than zero.

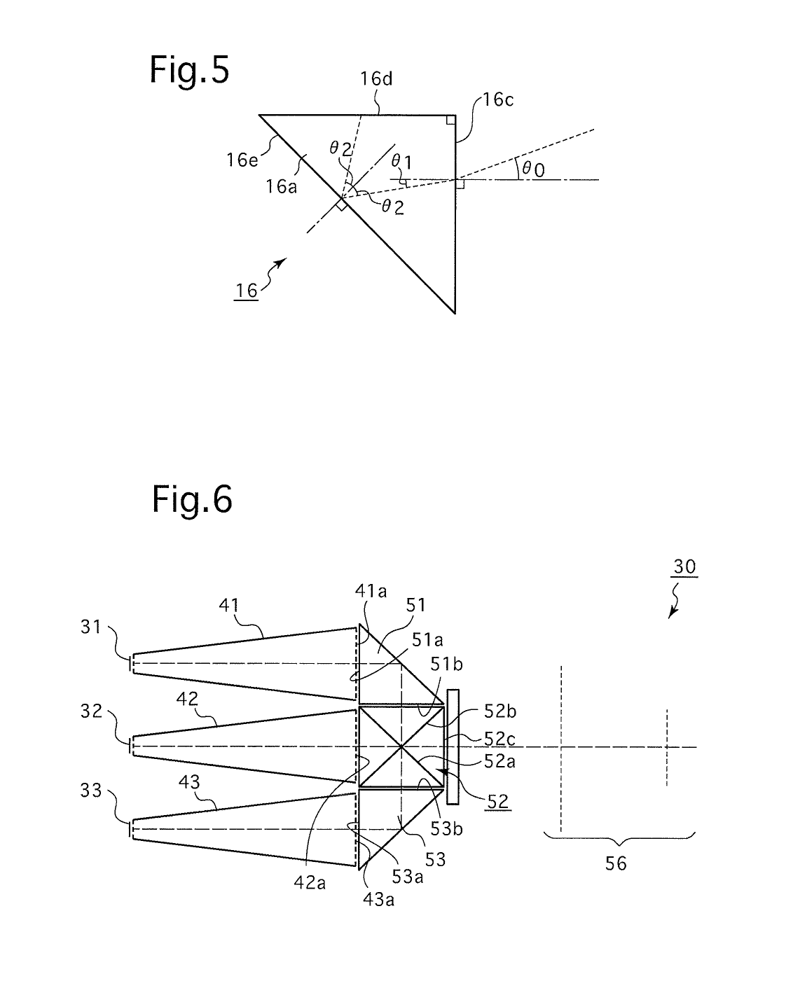

Here, conditions for the incident angle θ₀ on the right-angle prism 16 to make the incident light totally reflected at the oblique surface 16e of the right-angle prism 16 with a refractive index n will be discussed with reference to FIG. 5.

The following equation (A) is satisfied:

sin θ₀=n·sin θ₁ (A)

wherein θ₀ represents the incident angle of the incident light on the right-angle prism 16 from the light tunnel 14 with respect to the side surface 16c,

θ₁ represents the refracting angle of this incident light at the side surface 16c, and

θ₂ represents the incident angle of this refracting light on the oblique surface 16e.

In addition, the upper surface 16a of the right-angle prism 16 is an isosceles right triangle, and accordingly, the following equation (B) is satisfied:

θ₁=45−θ₂ (B)

Therefore, from these two equations, the following equation (C) is obtained:

sin(45−θ₂)=sin θ₀/n (C)

Hence, the following relational expression (D) between θ₂ and θ₀ is derived:

θ₂=45−a sin(sin θ₀/n) (D)

To this relation expression, if the following conditional expression (E) is assigned:

sin θ₂≧1/n (E),

the following conditional expression (F) can be derived:

45−a sin(sin θ₀/n)≧a sin(1/n) (F)

Likewise, conditions for making the incident light on the right-angle prism totally reflected by the upper surface 16a, the bottom surface 16b, the side surface 16c and the side surface 16d except for the oblique surface 16e during the time from the moment the incident light enters from the side surface 16c to the moment this entered light exits from the side surface 16d toward the outside of the right-angle prism 16 will be discussed hereinafter. In the case where light is incident on the upper surface 16a, the bottom surface 16b, the side surface 16c or the side surface 16d after entering from the side surface 16c, the following equation (G) is satisfied:

θ₁=90−θ₃ (G),

wherein θ₃ represents the incident angle of the incident light on the surface 16a, 16b, 16c or 16d.

Therefore, from the equations (A) and (G), the following equation (H) is obtained:

sin(90−θ₃)=sin_{—0}/n (H)

Hence, the following relational expression (I) between θ₃ and θ₀ is derived:

θ₃=90−a sin(sin θ₀/n) (I)

To this relation expression (I), if the following conditional expression (E) is assigned:

sin θ₃≧1/n (J),

the following conditional expression (K) can be derived:

90−a sin(sin θ₀/n)≧a sin(1/n) (K)

Comparing the conditional expression (F) with the conditional expression (K), the conditional expression (K) is always satisfied if the conditional expression (F) is satisfied because of the following condition:

90−a sin(sin θ₀/n)>45−a sin(sin θ₀/n).

Therefore, if light is made to be incident on the right-angle prism 16 at the incident angle θ₀ which satisfies the conditional expression (F), the light can be made to be totally reflected by each surface of the right-angle prism 16. The first embodiment of the picture display apparatus 1 is designed so that light incident on the right-angle prism 16 from the light tunnel 14 satisfies this condition. Accordingly, light which enters from the side surface 16c is incident on the oblique surface 16e directly or after being totally reflected by the upper surface 16a, the bottom surface 16b or the side surface 16d. The incident light on the oblique surface 16e is totally reflected thereby, and exits from the side surface 16d directly or after being totally reflected by the upper surface 16a, the bottom surface 16b or the side surface 16c. Since the incident light can be made to be totally reflected by inner surfaces of the right-angle prism 16, all the incident light can be made to exit from the side surface 16d as uniformed light with less loss of light quantity. It is possible for a reflection treatment (e.g., a coating) to be applied to the oblique surface 16e, the upper surface 16a and the bottom surface 16b. In this case, the reflection at each of the oblique surface 16e, the upper surface 16a and the bottom surface 16b is no a longer total reflection, and the light exit efficiency slightly reduces compared with total reflection; however, a reduction in cost of production can be achieved by use of a material with a low refractive index such as BK7 because it is not necessary to satisfy the aforementioned conditional expressions.

The outgoing light from the side surface 16d of the right-angle prism 16 is incident on the reflecting mirror 20 via the first relay lens 18, and the light reflected by the reflecting mirror 20 is incident on the image forming element 24 via the second relay lens 22. An LCD panel, for example, can be used as the image forming element 24. This LCD panel can be driven, pixel by pixel, by a drive system (not shown) selectively between a state (ON state) in which the incident light is allowed to pass through and a state (OFF state) in which the pixel is made not to allow the incident light to pass through to thereby shield the incident light.

The incident light on the image forming element 24 forms an image by turning ON (transmissive state) or OFF (non-transmissive state) each pixel, and the image thus formed is projected onto a screen (not shown) by the projector lens system 26.

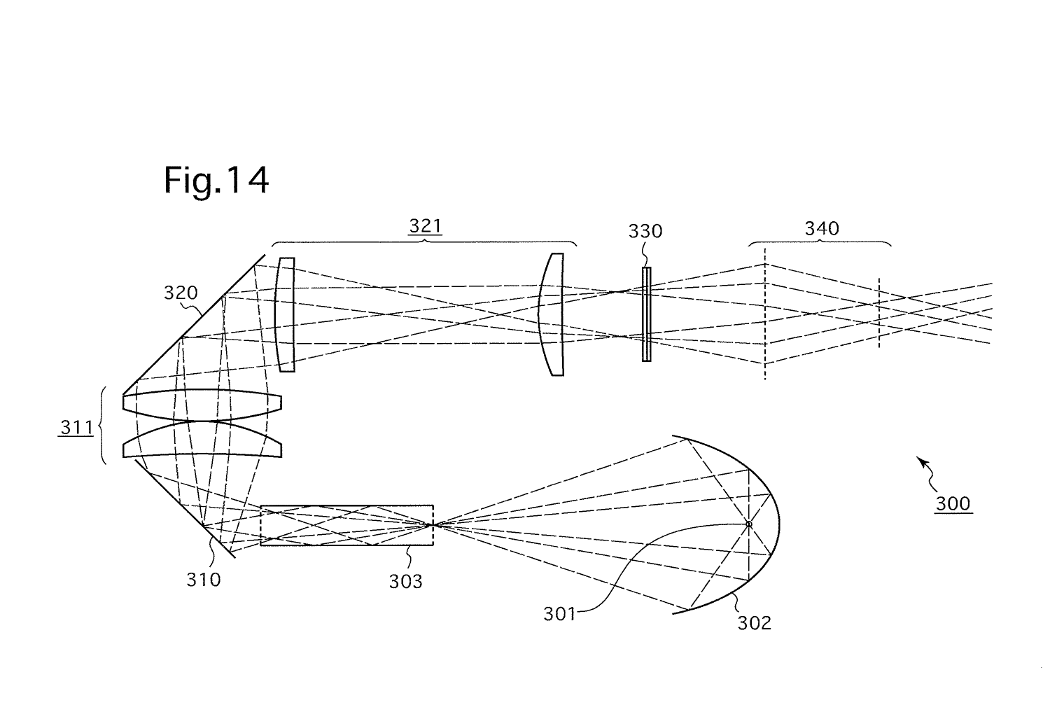

A light quantity, the light quantity of which is made uniform, is obtained even on the image forming element 24 due to the right-angle prism 16 being positioned in the close vicinity of the exit end of the light tunnel 14, light having a uniform light quantity being made to exit from the side surface 16d of the right-angle prism 16 and further due to an image on the exit surface 16d being formed on the image forming element 24 via the first relay lens system 18, the reflecting mirror 20 and the second relay lens system 22 as described above. In addition, in the case where the outgoing light from the light tunnel 303 is reflected by a mirror like in the conventional picture display apparatus 300 shown in FIG. 14, since the distance from the exit surface of the light tunnel 303 to the relay lens 311 via a mirror is great, the diameter of the relay lens 311 needs to be increased so as to make the reflected light incident on the relay lens 311. Moreover, the distance from the relay lens 311 to the picture display apparatus 300 also becomes great due to optical design. However, since it is possible to shorten the distance from the exit surface of the right-angle prism 16 to the first relay lens system 18 by adopting an arrangement in which the outgoing light from the light tunnel 14 is incident on the right-angle prism 16 in the first embodiment, the first relay lens system 18 can be miniaturized, which makes it possible to reduce the length of the illumination optical system from the light source 10 to the picture display apparatus 300, thus making it possible to miniaturize the entire apparatus 1. In addition, since the total reflection by the inner surface of each polished surface of the right-angle prism 16 is utilized, it is possible to improve efficiency (the ratio of the outgoing light to the incident light) compared with the case of using a mirror.

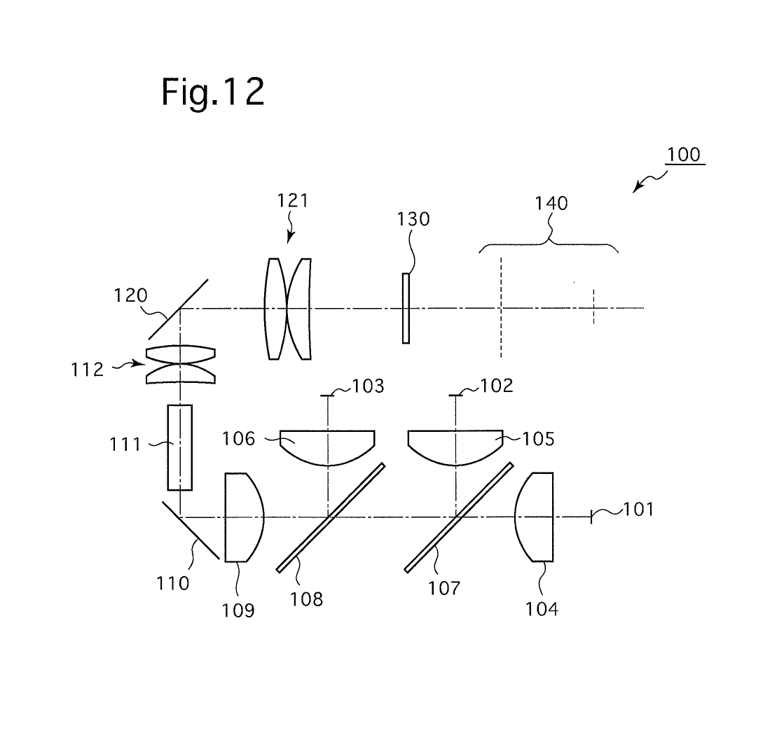

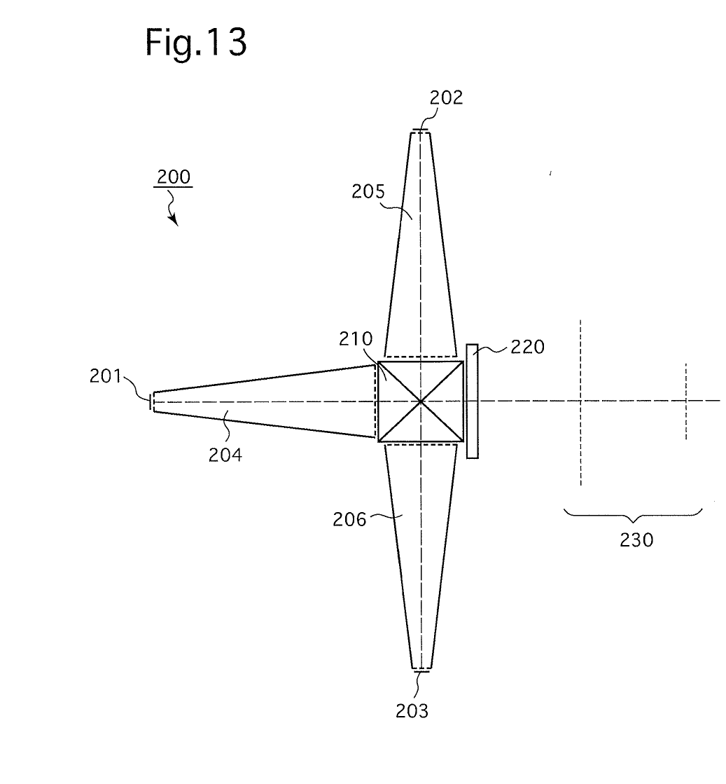

In addition, a right-angle prism can be positioned in the vicinity of the incident surface of a light tunnel. For instance, in the picture display apparatus 100 shown in FIG. 12, if a right-angle prism is placed in the close vicinity of the incident surface of the light tunnel 111 instead of the reflecting mirror 110, the length of the illumination system (the distances from the light sources 101, 102, 103 to the incident surface of the light tunnel 111) can be shortened and also the diameters of the condenser lenses 104, 105 and 106 can be reduced.

### Second Embodiment

A second embodiment will be hereinafter discussed with reference to FIG. 6.

Although the light source 10 is used as a white light source in the first embodiment, three LED light sources 31, 32 and 33 are used in the second embodiment of the picture display apparatus 30 instead of the light source 10. The emission color of each of the LED light sources 31, 32 and 33 can be set to any one of R, G and B colors; however, the case where the LED light sources 31, 32 and 33 emit R(red) light, G(green) light and B(blue) light, respectively, will be discussed hereinafter.

In the close vicinity of the LED light sources 31, 32 and 33, light rays from the LED light sources 31, 32 and 33 are incident on light tunnels (optical members) 41, 42 and 43 arranged in parallel with one another, respectively. The light which exits from the central light tunnel 42 among the three light tunnels 41, 42 and 43 is directly incident on a dichroic prism 52 disposed in the close vicinity of the exit surface 42a of the light tunnel 42 without changing the traveling direction.

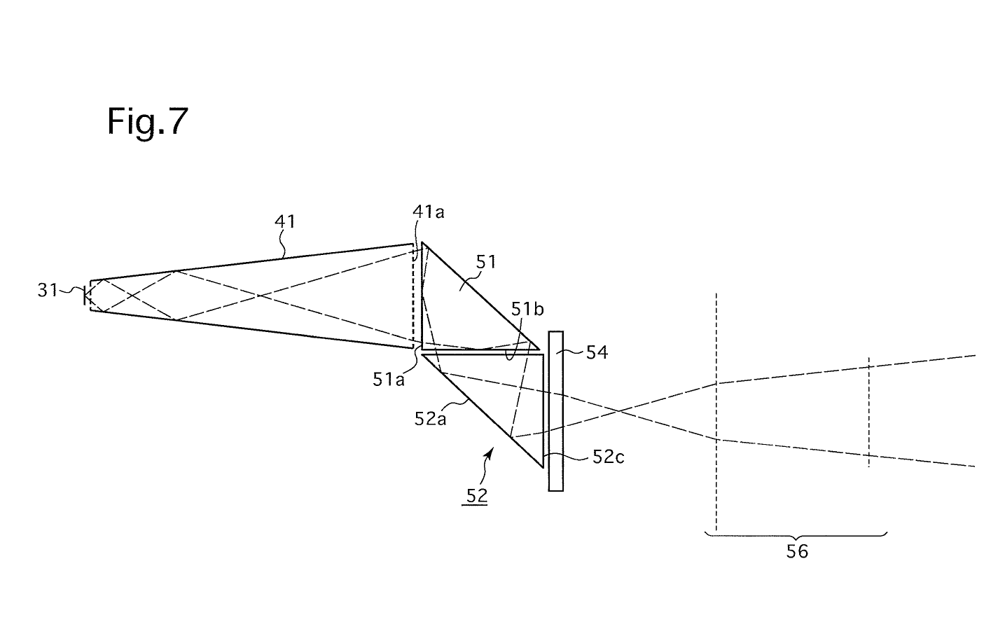

Conversely, the light rays which exit from the two light tunnels 41 and 43 that are arranged in parallel with the light tunnel 42 are incident on the right-angle prisms 51 and 53 in the vicinity of the exit surfaces 41a and 43a, respectively. Similar to the right-angle prism 16 of the first embodiment, all the five surfaces of each of the right-angle prisms 51 and 53 are formed as polished surfaces, and the incident angles from the light tunnels 41 and 43 satisfy the aforementioned conditional expression (F). Therefore, the light rays which enter from the incident surfaces 51a and 53 are totally reflected by the inner surfaces of the right-angle prisms 51 and 53 to exit entirely from the exit surfaces 51b and 53b toward the dichroic prism 52 that is disposed in the close vicinity thereof, respectively (see FIG. 7). The outgoing light rays from the exit surfaces 51b and 53b are made uniform in light quantity at the exit surfaces 51b and 53b of the right-angle prisms 51 and 53, respectively. The outgoing light rays from the right-angle prisms 51 and 53 are incident on the dichroic prism 52 from opposite directions along a direction orthogonal to the optical axis of the central light tunnel 42. Although only the light which is emitted from the LED light source 31 to be incident on the dichroic prism 52 via the light tunnel 41 and the right-angle prism 51 is shown in FIG. 7 for the purpose of illustration, the same is true on the light which is emitted from the LED light source 33 to be incident on the dichroic prism 52 via the light tunnel 43 and the right-angle prism 53. In this case, it is desirable that an air distance (e.g., more than 0 and smaller than 10 mm) be provided between each of the exit surfaces of the two right-angle prisms 51 and 53 and the dichroic prism. This is to prevent the uniformity of the outgoing light from the dichroic prism and the right-angle prisms from deteriorating and further prevent illumination efficiency from deteriorating because, if the air distance is set to zero, the totally reflected light in the case where the air distance exists is not totally reflected at either of the contacting surfaces where the dichroic mirror and the right-angle prisms are in contact with each other, but passes through from the inside of each right-angle prism into the dichroic mirror, or vice versa.

All the six outer surfaces of the dichroic prism 52 that form a substantially regular hexahedron are polished surfaces, and the dichroic prism 52 that is square as viewed in plan view is provided therein, on the two diagonal lines thereof, with coated surfaces 52a and 52b, respectively. The coated surfaces 52a and 52b each have wavelength selectivity which reflects light with a specific wavelength and allows light with other wavelengths to pass through. Although wavelength selectivity which reflects red light and allows green light and blue light to pass through is given to the coated surface 52a while wavelength selectivity which reflects blue light and allows green light and red light to pass through is given to the coated surface 52b in the second embodiment, the combinations of reflection and transmission can be freely set.

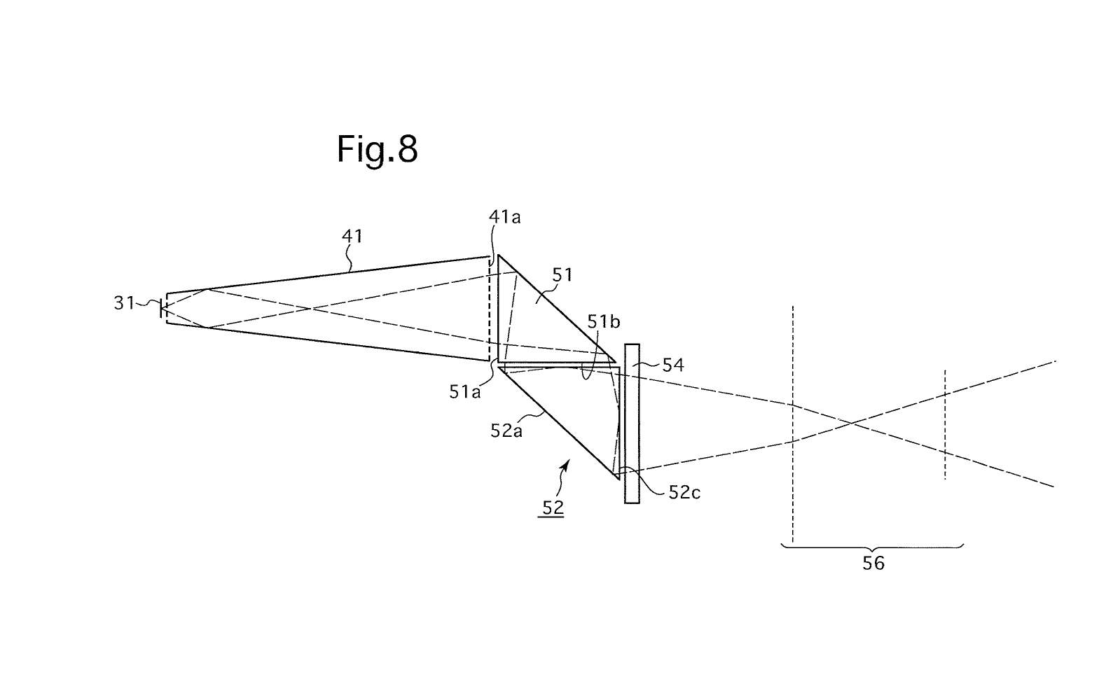

The green light which exits from the central light tunnel 42 passes through the two coated surfaces 52a and 52b and exits from the exit surface 52c after being incident on the dichroic prism 52. In contrast to this, the red light which exits from the right-angle prism 51, is reflected by the coated surface 52a and exits from the exit surface 52c after being incident on the dichroic prism 52. The blue light which exits from the right-angle prism 53, is reflected by the coated surface 52b and exits from the exit surface 52c after being incident on the dichroic prism 52. Since all the six outer surfaces of the dichroic prism 52 are polished surfaces, the light which enters the dichroic prism 52 from each incident surface thereof at this time, for instance, the green light which exits from the central light tunnel 42, directly reaches the exit surface 52c or is totally reflected by the four side surfaces and thereafter reaches the exit surface 52c, after being incident on the dichroic prism 52. In addition, after being incident on the dichroic prism 52, the red light which exits from the right-angle prism 51 directly reaches the coated surface 52a, or is totally reflected by the upper surface, the bottom surface or the exit surface 52c and thereafter reaches the coated surface 52a. After being reflected by the coated surface 52a, rays of light incident on the coated surface 52a directly reach the exit surface 52c, or are totally reflected by the upper surface, the bottom surface or the incident surface and thereafter reach the exit surface 52c (see FIG. 8). The same is true for the blue light which exits from the right-angle prism 53. In this manner, all the light can be made to exit from the exit surface 52c, and the light quantity of the outgoing light at the exit surface of the dichroic prism 52 can be made uniform. Although only the light which is emitted from the LED light source 31 to be incident on the dichroic prism 52 via the light tunnel 41 and the right-angle prism 51 is shown in FIG. 8 for the purpose of illustration, the same is true for the light which is emitted from the LED light source 33 to be incident on the dichroic prism 52 via the light tunnel 43 and the right-angle prism 53.

The outgoing light from the dichroic prism 52 is incident on an image forming element 54. An LCD panel, for example, can be used as the image forming element 54, similar to the image forming element 24. This LCD panel can be driven, pixel by pixel, by a drive system (not shown) selectively between a state (ON state) in which the incident light is allowed to pass through and a state (OFF state) in which the pixel is made not to allow the incident light to pass through to thereby shield the incident light. The incident light on the image forming element 54 forms an image by turning ON (transmissive state) or OFF (non-transmissive state) each pixel, and the image thus formed is projected onto a screen (not shown) by a projector lens system (projector lens) 56. At this time, by switching red, green and blue light emissions of the LED light sources 31, 32 and 33 with time and making the image forming element 54 also form an image of each color in synchronization with the switching operation, a desired color image can be indicated on the screen.

The light quantities of light rays incident on the right-angle prisms 51 and 53 can be made uniform at the exit surfaces 51b and 53b, respectively, because the right-angle prisms 51 and 53 are arranged in the close vicinity of the exit surfaces 41a and 43a of the light tunnels 41 and 43, respectively, that are arranged in parallel with each other on both sides of the central light tunnel 42 as described above. On the other hand, the light quantity is made uniform also at the exit surface 42a of the central light tunnel 42. Moreover, the light quantity at the exit surface 52c is made uniform because all six outer surfaces of the dichroic prism 52 that constitute the dichroic prism 52 are polished surfaces. Accordingly, a uniformed light quantity can be obtained even on the image forming element 54 that is disposed in the vicinity of the exit surface 52c of the dichroic prism 52. Furthermore, as compared with the conventional optical system shown in FIG. 12, a substantial reduction in number of components can be achieved, and the entire picture display apparatus 30 can be miniaturized because the dimensions of the illumination system can also be reduced. Furthermore, losses such as surface reflection can be reduced and the efficiency thereof can be enhanced since optical elements are few.

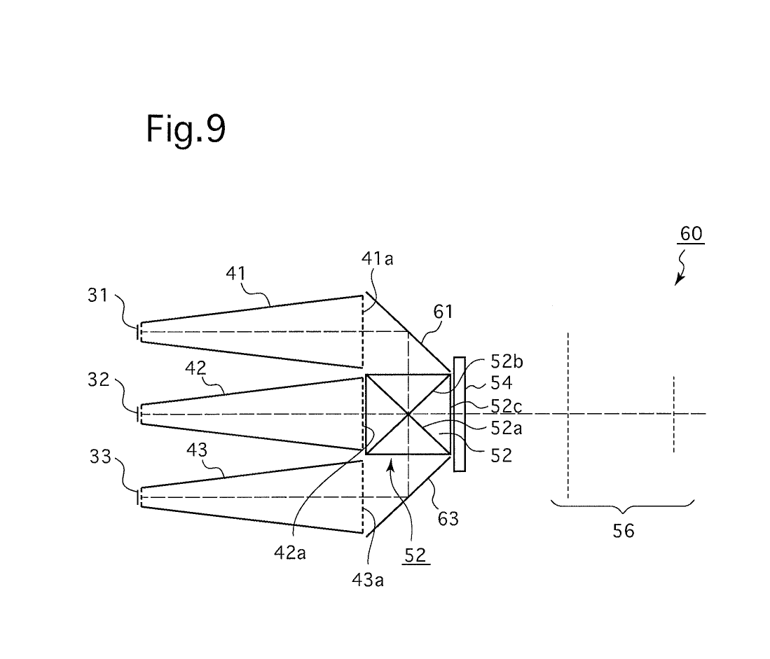

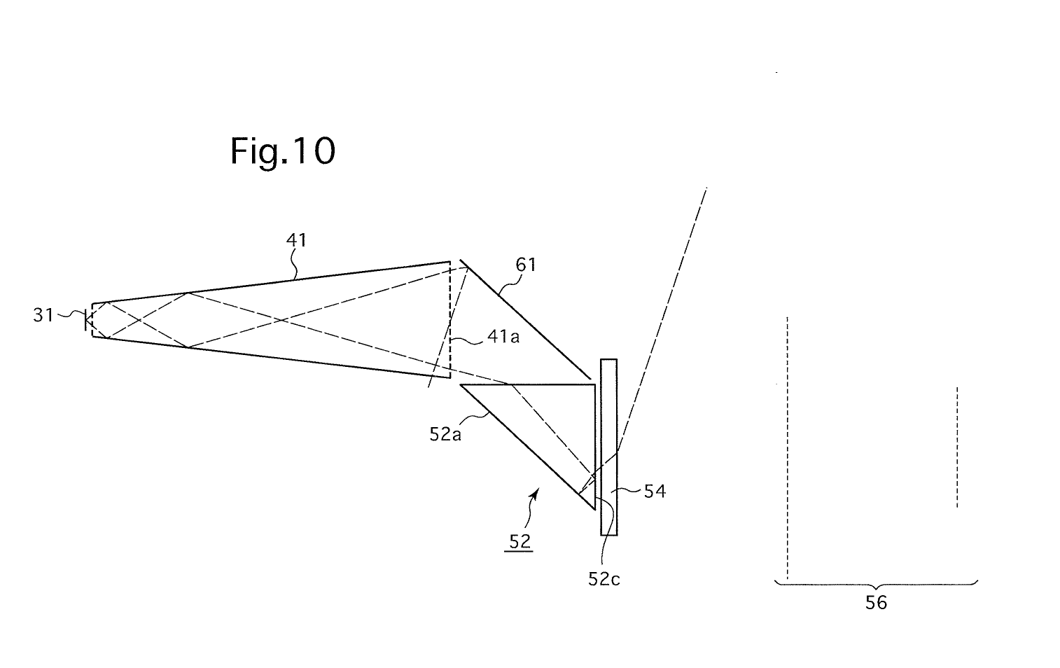

As a comparative example to be compared with the second embodiment, a picture display apparatus 60 using mirrors 61 and 63 instead of using the right-angle prisms 51 and 53 of the picture display apparatus 30 will be hereinafter discussed with reference to FIGS. 9 and 10. In the picture display apparatus 60, the outgoing light rays from the light tunnels 41 and 43 are reflected by the mirrors 61 and 63 that are positioned in the close vicinity of 41a and 43a, respectively, and the lights thus reflected are incident on the dichroic prism 52 from opposite directions along a direction orthogonal to the optical axis of the central light tunnel 42.

However, as shown in FIG. 10, there are rays of light which exit from the light tunnels 41 and 43 to be reflected by the mirrors 61 and 63 but thereafter are not incident on the dichroic prism 52, and other rays of light which are not incident on the mirrors 61 and 63 but directly on the dichroic prism 52 after exiting out of the light tunnels 41 and 43, and it can be understood that these rays of light are not eventually incident on the projector lens system 56. In contrast to this, in the above described second embodiment, all the rays of light incident on the right-angle prism 51 and 53 and also the dichroic mirror 52 can be lead to the image forming element 54 because the right-angle prisms 51 and 53 are disposed in the close vicinity of the exit surfaces 41a and 43a of the light tunnels 41 and 43, respectively, and further because the dichroic prism 52 is disposed in the close vicinity of the exit surface 42a of the light tunnel 42. Accordingly, as compared with the case of using the mirrors 61 and 63 like the comparative example, the outgoing lights from the LED light sources 31, 32 and 33 can be made to be incident on the projector lens system 56 with a high degree of efficiency. Although only the light which is emitted from the LED light source 31 to be reflected by mirror 61 via the light tunnel 41 is shown in FIG. 10 for the purpose of illustration, the same is true for the light which is emitted from the LED light source 33 to be reflected by mirror 63 via the light tunnel 43 as illustrated above.

Next, a modified example of the second embodiment will be discussed hereinafter.

Although a single piece of image forming element 54 is placed in the close vicinity of the exit surface 52c of the dichroic prism 52 in the second embodiment, it is possible for three image forming elements for red, green and blue to be arranged in the close vicinity of the three incident surfaces of the dichroic prism 52 on which red, green and blue lights are incident, respectively. According to this arrangement, light emissions of the LED light sources 31, 32 and 33 do not need to be switched with time, and accordingly, approximately three times of brightness can be obtained as compared with the case of using a single image forming element.

In addition, instead of the three light tunnels 41, 42 and 43, three rod lenses (rod-shaped glass lenses) arranged in a similar manner can be used. In this case, it is desirable to provide an air distance (e.g., more than 0 and less than 10 mm) between each of the two rod lenses arranged on both sides and the associated right-angle prism. This is to prevent the uniformity of the outgoing light from each right-angle prism from deteriorating and further prevent illumination efficiency from deteriorating because, if the air distance is set to zero, totally reflected light in the case where the air distance exists is not totally reflected at either of the contacting surfaces where the two rod lenses and the two right-angle prisms are in contact with each other but passes through from the inside of each right-angle prism into the associated rod lens, or vice versa.

Other functions, effects and modified examples are similar to those of the first embodiment.

### Third Embodiment

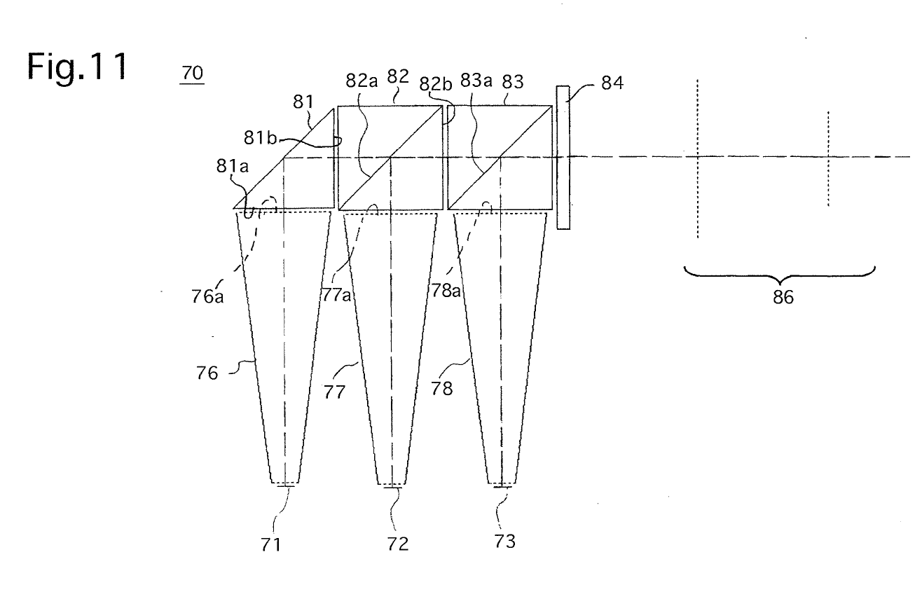

A third embodiment will be hereinafter discussed with reference to FIG. 11.

In the third embodiment of the picture display apparatus 70, three LED light sources 71, 72 and 73 are used similarly to the second embodiment of the picture display apparatus 30. The emission color of each of the LED light sources 71, 72 and 73 can be set to any one of R, G and B colors; however, the case where the LED light sources 71, 72 and 73 emit R(red) light, G(green) light and B(blue) light, respectively, will be discussed hereinafter.

Light rays from the LED light sources 71, 72 and 73 are incident on light tunnels (optical members) 76, 77 and 78, arranged in parallel with one another, respectively, at the close vicinity of the LED light sources 71, 72 and 73. The light which exits from the light tunnel 76 that is disposed on the far side from a projector lens 86 is incident on a right-angle prism 81 disposed in the close vicinity of the exit surface 76a of the light tunnel 76. Similar to the right-angle prism 16 of the first embodiment, all the five surfaces of the right-angle prism 81 are formed as polished surfaces, and the incident angle from the light tunnel 76 satisfies the aforementioned conditional expression (F). Therefore, the light which enters from the incident surface 81a is totally reflected by the inner surfaces of the right-angle prism 81 to exit entirely from the exit surface 81b toward a dichroic prism 82 disposed in the close vicinity of the exit surface 81b.

The outgoing light from the central light tunnel 77 that is disposed in parallel with the light tunnel 76 is incident on a first dichroic prism 82 disposed in the close vicinity of the exit surface 77a of the light tunnel 77. All the six outer surfaces of the first dichroic prism 82 that form a substantially regular hexahedron are polished surfaces, and the dichroic prism 82 that is square as viewed in plan view is provided therein, on a diagonal line of the dichroic prism 82, with a coated surface 82a. The coated surface 82a has wavelength selectivity which reflects light with a specific wavelength and allows light with other wavelengths to pass through. Although wavelength selectivity which allows red light to pass through and reflects green light is given to the coated surface 82a in the third embodiment, the combination of reflection and transmission can be freely set.

In this case, it is desirable to provide an air distance (e.g., more than 0 and less than 10 mm) between the exit surface of the right-angle prism 81 and the first dichroic prism 82. This is to prevent the uniformity of the outgoing light from the first dichroic prism 82 and the right-angle prism 81 from deteriorating and further prevent illumination efficiency from deteriorating because, if the air distance is set to zero, the totally reflected light in the case where the air distance exists is not totally reflected at the contacting surface where the right-angle prism 81 and the first dichroic prism 82 are in contact with each other but passes through from the inside of the right-angle prism 81 into the first dichroic prism 82, or vice versa. In this manner, the red light and the green light which are combined with each other in the first dichroic prism 82 exit from the exit surface 82b toward a second dichroic prism 83 disposed in the vicinity of the exit surface 82b.

The outgoing light from the light tunnel 78 on the projector lens 86 side, which is disposed parallel with the light tunnels 76 and 77, is incident on the second dichroic prism 83 that is disposed in the close vicinity of the exit surface 78a of the light tunnel 78. All the six outer surfaces of the second dichroic prism 83 that form a substantially regular hexahedron are polished surfaces, and the second dichroic prism 83 is provided therein, on a diagonal line of the dichroic prism 83 that is square as viewed in plan view, with a coated surface 83a. The coated surface 83a has wavelength selectivity which reflects light with a specific wavelength and allows light with other wavelengths to pass through. Although wavelength selectivity which allows red light and green light to pass through and reflects blue light is given to the coated surface 83a in the third embodiment, the combination of reflection and transmission can be freely set. In this case, it is desirable to provide an air distance (e.g., more than 0 and less than 10 mm) between the exit surface of the first dichroic prism 82 and the second dichroic prism 83. This is to prevent the uniformity of the outgoing light from the first dichroic prism 82 and the second dichroic prism from deteriorating and further prevent illumination efficiency from deteriorating because, if the air distance is set to zero, the totally reflected light in the case where the air distance exists is not totally reflected at the contacting surface where the first dichroic prism 82 and the second dichroic prism 83 are in contact with each other but passes through from the inside of the first dichroic prism 82 into the second dichroic prism 83, or vice versa.

Since all the six outer surfaces of the first dichroic prism 82 are polished surfaces, the light which enters the first dichroic prism 82 from each incident surface thereof at this time, for instance, the red light which exits from the right-angle prism 81, directly reaches the exit surface 82b or is totally reflected by the four side surfaces and thereafter reaches the exit surface 82b after being incident on the first dichroic prism 82. In addition, after being incident on the first dichroic prism 82, the green light which exits from the central light tunnel 77 directly reaches the coated surface 82a, or is totally reflected by the upper surface, the bottom surface or the exit surface 82b and thereafter reaches the coated surface 82a. After being reflected by the coated surface 82a, the light incident on the coated surface 82a directly reaches the exit surface 82b, or is totally reflected by the upper surface, the bottom surface or the exit surface 82b and thereafter reaches the exit surface 82b. In this manner, all the incident light can be made to exit from the exit surface 82b, and the light quantity of the outgoing light at the exit surface 82b of the first dichroic prism 82 can be made uniform. Similar to the lights incident from the second dichroic prism 83, all the incident lights can be made to exit from the exit surface 83b, and the light quantity of the outgoing light at the exit surface of the second dichroic prism 83 can be made uniform.

The outgoing light from the second dichroic prism 83 is incident on an image forming element 84. An LCD panel, for example, can be used as the image forming element 84, similar to the image forming element 24 of the first embodiment. This LCD panel can be driven, pixel by pixel, by a drive system (not shown) selectively between a state (ON state) in which the incident light is allowed to pass through and a state (OFF state) in which the pixel is made not to allow the incident light to pass through to thereby shield the incident light. The incident light on the image forming element 84 forms an image by turning ON (transmissive state) or OFF (non-transmissive state) each pixel, and the image thus formed is projected onto a screen (not shown) by a projector lens system (projector lens) 86. At this time, by switching red, green and blue light emissions of the LED light sources 71, 72 and 73 with time and making the image forming element 84 also form an image of each color in synchronization with the switching operation, a desired color image can be indicated on the screen.

With the above described arrangement in which the right-angle prism 81 is disposed in the close vicinity of the exit surface 76a of the light tunnel 76 on the far side from the projector lens 86, in which the first dichroic prism 82 is disposed in the close vicinity of the exit surface 81b of the right-angle prism 81 and the exit surface 77a of the central light tunnel 77, and in which the second dichroic prism 83 is disposed in the close vicinity of the exit surface 82b of the first dichroic prism 82 and the exit surface 78a of the light tunnel 78 on the projector lens 86 side, and further with the above described configuration in which all the outer surfaces of the right-angle prism 81 and the first and second dichroic prisms are made as polished surfaces, the rays of light incident on these outer surfaces from inside are totally reflected, and accordingly, the light rays emitted from the three LED light sources, respectively, efficiently exit out of the exit surface 83b of the second dichroic prism 83, and the light quantity at the exit surface 83b is made uniform. On this account, a uniformed light quantity can be obtained even on the image forming element 84 that is disposed in the close vicinity of the exit surface 83b of the second dichroic prism 83. Furthermore, compared with the conventional optical system shown in FIG. 12, a substantial reduction in number of components can be achieved, and the entire picture display apparatus 70 can be miniaturized because the dimensions of the illumination system can also be reduced. Furthermore, losses such as surface reflection can be reduced and the efficiency can be enhanced since optical elements are few.

In addition, instead of the three light tunnels 76, 77 and 78, three sets of light-condensing optical systems each composed of one or a plurality of lenses can be used. In addition, the uniformity of the image forming element 84 can further be enhanced by inserting a light tunnel or a rod lens in between the second dichroic prism and the image forming element.

Other functions, effects and modified examples are similar to those of the first and second embodiments.

Although the present invention has been discussed with reference to the above described embodiments, the present invention is not limited to these embodiments; these embodiments can be improved or modified within the spirit of the present invention or the object for improvement.

### INDUSTRIAL APPLICABILITY

According to the present invention, the arrangement in which a right-angle prism is disposed in the close vicinity of the incident or exit surface of a light tunnel (or rod lens) makes it possible to miniaturize the picture display apparatus compared with a convention example in which a reflection mirror is disposed instead. Moreover, the picture display apparatus can be miniaturized because the relay lens on which the outgoing light from the right-angle prism is incident can be miniaturized. Furthermore, illumination efficiency can be enhanced because total reflection by inner surfaces of the right-angle prism is utilized. Furthermore, in the type of apparatus using light sources of three colors, since a degree of freedom can be given to the arrangement of the three light sources by an arrangement which makes rays of light which are emitted from the light sources of two colors (except for the central light source) incident on a dichroic prism after making the same rays of light incident on the right-angle prism, miniaturization of the apparatus can be achieved, and the cost of the apparatus can be reduced because neither a condenser lens nor a relay lens is used.

1. A picture display apparatus comprising:
a light source;
a light-condensing optical system which condenses rays of light from said light source to form an imaginary secondary light source;
an optical member on which said rays of light that are condensed by said light-condensing optical system are incident;
a right-angle prism through which said rays of light that exit from said optical member pass;
a relay lens through which said rays of light that exit from said right-angle prism pass;
an image forming element on which said rays of light that exit from said relay lens are incident; and
a projector lens on which said rays of light that pass through said image forming element are incident, and which magnifies and projects said rays of light incident on said projector lens,
wherein five surfaces which constitute said right-angle prism are all formed as polished surfaces and disposed in a close vicinity of an exit surface of said optical member.

2. A picture display apparatus comprising:
a light source;
a light-condensing optical system which condenses rays of light from said light source to form an imaginary secondary light source;
a right-angle prism on which said rays of light that are condensed by said light-condensing optical system are incident;
an optical member through which said rays of light that exit from said right-angle prism pass;
a relay lens through which said rays of light that exit from said optical element pass;
an image forming element on which said rays of light that exit from said relay lens are incident; and
a projector lens on which said rays of light that pass through said image forming element are incident, and which magnifies and projects said rays of light incident on said projector lens,
wherein five surfaces which constitute said right-angle prism are all formed as polished surfaces and positioned in a close vicinity of an incident surface of said optical member.

3. The picture display apparatus according to claim 1 or claim 2, wherein a reflection treatment is applied to an oblique surface of said right-angle prism.

4. The picture display apparatus according to one of claims 1 through 3, wherein said optical member is a light tunnel.

5. The picture display apparatus according to one of claims 1 through 3, wherein said optical member is a rod lens, an air distance exiting between said right-angle prism and said rod lens.

6. The picture display apparatus according to one of claims 1 through 5, wherein said light-condensing optical system is a condenser mirror.

7. The picture display apparatus according to one of claims 1 through 5, wherein said light source is an LED, and said light-condensing optical system is a condenser lens system.

8. A picture display apparatus comprising:
three LED light sources which emit red light, green light and blue light, respectively;
three optical members which are arranged parallel to one another and on which rays of said red light, rays of said green light and rays of said blue light from said three LED light sources are incident, respectively;
two right-angle prisms corresponding to two of said three optical members except for a central optical member thereof, light rays which exit from said two of said three optical members passing through said two right-angle prisms, respectively;
a dichroic prism on which said light rays that exit from said central optical member and said light rays that exit from said two of said three optical members are incident, and which combines said red, green and blue light rays together and allows said combined light rays pass therethrough;
an image forming element on which said light rays that exit from said dichroic prism are incident; and
a projector lens on which said light rays that pass through said image forming element are incident, and which magnifies and projects said light rays incident on said projector lens,
wherein six outer surfaces which constitute said dichroic prism are all formed as polished surfaces, and five surfaces which constitute each of said right-angle prisms are all formed as polished surfaces,
wherein said right-angle prisms are disposed in a close vicinity of exit surfaces of said two of said three optical members except for said central optical member, respectively, and
wherein an air distance exists between each said right-angle prism and said dichroic prism.

9. A picture display apparatus comprising:
three LED light sources which emit red light, green light, and blue light, respectively;
three optical members which are arranged parallel to one another and on which rays of said red light, rays of said green light and rays of said blue light from said three LED light sources are incident, respectively;
right-angle prisms corresponding to two of said three optical members except for a central optical member thereof, light rays which exit from said two of said three optical members passing through said two right-angle prisms, respectively;
three image forming elements on which said light rays that exit from said central optical member and said light rays that exit from said two of said three optical members are incident;
a dichroic prism on which said light rays that exit from said three image forming elements are incident, and which combines said light rays incident on said dichroic prism together and allows said combined light rays to pass therethrough;
a projector lens on which said light rays that pass through said dichroic prism are incident, and which magnifies and projects said light rays incident on said projector lens,
wherein six outer surfaces which constitute said dichroic prism are all formed as polished surfaces, and five surfaces which constitute each of said right-angle prisms are all formed as polished surfaces,
wherein said right-angle prisms are disposed in a close vicinity of exit surfaces of said two of said three optical members except for said central optical member, respectively, and
wherein an air distance exists between each of said right-angle prisms and said dichroic prism.

10. The picture display apparatus according to claim 8 or claim 9, wherein a reflection treatment is applied to an oblique surface of each of said right-angle prisms.

11. The picture display apparatus according to one of claims 8 through 10, wherein said optical members are light tunnels.

12. The picture display apparatus according to one of claims 8 through 11, wherein said optical members are rod lenses, and wherein air distances exist between said rod lenses except for a central rod lens thereof and said right-angle prisms, respectively.

13. A picture display apparatus equipped with a projector lens which magnifies and projects incident light, said picture display apparatus comprising:
three LED light sources which emit red light, green light, and blue light, respectively;
three optical members which are arranged parallel to one another and on which rays of said red light, rays of said green light and rays of said blue light from said three LED light sources are incident, respectively;
a right-angle prism through which light rays, which exit from an optical member among said three optical members positioned on a far side from said projector lens, pass;
a first dichroic prism on which said light rays that exit from a central optical member among said three optical members and said light rays that exit from said right-angle prism are incident, and which combines two of said red, green and blue light rays together and allows said combined light rays pass therethrough;
a second dichroic prism on which said light rays that exit from an optical member among said three optical members which is positioned on said projector lens side and said light rays that exit from said first dichroic prism are incident, and which combines said red, green and blue light rays together and allows said combined light rays pass therethrough; and
an image forming element on which said light rays that exit from said second dichroic prism are incident and pass through said image forming element toward said projector lens,
wherein six outer surfaces which constitute said first dichroic prism and six outer surfaces which constitute said second dichroic prism are all formed as polished surfaces, and five surfaces which constitute said right-angle prism are all formed as polished surfaces,
wherein said right-angle prism is disposed in a close vicinity of an exit surface of an optical member among said three optical members which is positioned on a far side from said projector lens,
wherein said first dichroic prism is disposed in a vicinity of an exit surface of said right-angle prism and an exit surface of said central optical member,
wherein said second dichroic prism is disposed in a close vicinity of an exit surface of said first dichroic prism and an exit surface of an optical member among said three optical members which is positioned on said projector lens side, and
wherein an air distance exists between said right-angle prism and said first dichroic prism and an air distance exists between first dichroic prism and said second dichroic prism.

14. The picture display apparatus according to claim 13, wherein a reflection treatment is applied to an oblique surface of said right-angle prism.

15. The picture display apparatus according to claim 13 or claim 14, wherein said optical members are light tunnels.

16. The picture display apparatus according to claim 13 or claim 14, wherein said optical members are rod lenses, and
wherein an air distance exists between each said rod lenses and associated one of said right-angle prism, said first dichroic prism and said second dichroic prism.

17. The picture display apparatus according to claim 13 or claim 14, wherein each of said optical members comprises a lens or a plurality of lenses.

18. The picture display apparatus according to one of claims 13 through 16, further comprising a light tunnel between said second dichroic prism and said image forming element.

19. The picture display apparatus according to one of claims 13 through 16, further comprising a rod lens between said second dichroic prism and said image forming element.
